(19) United States
(12) Patent Application Publication
(10) Pub. No.: US 2025/0118217 A1
(43) Pub. Date: Apr. 10, 2025

(54) METHOD FOR CONSTRUCTING A SIMPLIFIED REPRESENTATION OF OBSTACLES IN THE VICINITY OF AN AIRPORT

(71) Applicant: Airbus Operations (S.A.S.), Toulouse (FR)

(72) Inventors: Thomas Pastre, Toulouse (FR); Miguel CONSIGLIERI PEDROSO MENDES DIAS, Toulouse (FR)

(21) Appl. No.: 18/905,585

(22) Filed: Oct. 3, 2024

(30) Foreign Application Priority Data
Oct. 9, 2023 (FR) FR2310790

(51) Int. Cl. G08G 5/00; G01C 5/00

(52) U.S. Cl. CPC G08G 5/74; G01C 5/005; G08G 5/32

(57) ABSTRACT

A simplified representation of obstacles in the vicinity of an airport strip is constructed by obtaining information on the elevation of the terrain in the vicinity of the airport strip, applying filtering by following a filtering profile in the shape of a cone the apex of which is placed at one end of the airport strip, the rotation axis of the cone being perpendicular to the airport strip, the cone having an outer surface forming a predetermined angle a with the airport strip, the filtering eliminating the information on the elevation of terrain having an altitude which is lower than the filtering profile. The terrain elevation information remaining after filtering is stored as relevant obstacle information. Thus, the volume of elevation data to be stored and to be processed on take-off or on landing is reduced.

### TECHNICAL FIELD

At least one embodiment disclosed here relates to a method for constructing a simplified representation of obstacles in the vicinity of an airport strip, retaining only terrain elevation information which is relevant for a take-off, a landing or a go-around of an aircraft.

At least one embodiment disclosed here relates to a method for using the simplified representation of obstacles in the vicinity of an airport strip thus obtained.

### BACKGROUND

For various applications in aeronautics, notably for computing or following a flyable trajectory, terrain information is used. This terrain information provides, in particular, terrain elevation indications and, more generally: locations and heights of buildings, of trees, of mountainous areas and more generally of obstacles which may be encountered by aircraft in flight. These terrain elevation indications are notably stored in databases on board the aircraft, in order to make it possible for the pilots or for the avionics of these aircraft to compute or follow a flyable trajectory. A flyable trajectory is a trajectory which has, at all points, a minimum (or predetermined) distance margin with respect to any identified obstacle (relief, etc.) and which the aircraft can follow given its operational state (potential depressurization, loss of an engine, etc.).

In the vicinity of airports and landing strips, a precise representation of the neighboring terrain is used, because of the complexity of the environment in terms of potential obstacles. One problem is that this represents a high volume of data, to be stored in a database, on the one hand, and to be processed on the departure and/or on the arrival of flights, on the other hand. It is, then, desirable to mitigate this drawback of the prior art.

### SUMMARY

A method is disclosed for constructing a simplified representation of obstacles in the vicinity of an airport strip, the method being implemented by a system in the form of electronic circuitry, the method comprising the following steps: obtaining information on the elevation of the terrain in the vicinity of the airport strip; applying filtering by following a filtering profile in the shape of a cone the apex of which is placed at one end of the airport strip, the rotation axis of the cone being perpendicular to the airport strip, the cone having an outer surface forming a predetermined angle α with the airport strip, the filtering eliminating the information on the elevation of terrain having an altitude which is lower than the filtering profile; and storing, as relevant obstacle information, the terrain elevation information remaining after filtering. Thus, the volume of terrain elevation data to be stored and to be processed on take-off and on landing is reduced.

According to an embodiment, at a distance d, the cone shape reaches a predetermined height h corresponding to a saturation threshold and, beyond the distance d with respect to the end of the airport strip, the filtering profile is flat.

According to an embodiment, the system applies one filtering profile to each end of the airport strip.

According to an embodiment, the system obtains a filtering profile to be applied for the whole of the airport strip, called an individual filtering profile, by combining a first filtering sub-profile defined for one end of the airport strip and a second filtering sub-profile defined for the other end of the airport strip, so that the information on the elevation of terrain the altitude of which is lower than the lowest-altitude filtering sub-profile is eliminated.

According to an embodiment, when at least one other airport strip is nearby, the system defines one individual filtering profile for each airport strip, and the system obtains an overall filtering profile to be applied for all of the airport strips, by combining the individual filtering profiles, so that the information on the elevation of terrain the altitude of which is lower than the lowest-altitude individual filtering profile is eliminated.

Also disclosed here is a method for determining or for following a trajectory of an aircraft in the vicinity of an airport, wherein a system in the form of electronic circuitry determines or follows a trajectory of an aircraft by using a simplified representation of obstacles in the vicinity of the airport strip which is obtained by the method presented above, in any one of its embodiments.

Also disclosed here is a computer program product comprising program code instructions causing one or other of the above methods, in any one of their embodiments, to be implemented when the instructions are executed by a processor. Also disclosed here is an information storage medium storing such program code instructions.

Also disclosed here is a system in the form of electronic circuitry configured to construct a simplified representation of obstacles in the vicinity of an airport strip by implementing the following steps: obtaining information on the elevation of the terrain in the vicinity of the airport strip; applying filtering by following a filtering profile in the shape of a cone the apex of which is placed at one end of the airport strip, the rotation axis of the cone being perpendicular to the airport strip, the cone having an outer surface forming a predetermined angle a with the airport strip, the filtering eliminating the information on the elevation of terrain having an altitude which is lower than the filtering profile; and storing, as relevant obstacle information, the terrain elevation information remaining after filtering.

### BRIEF DESCRIPTION OF THE DRAWINGS

The above-mentioned features of the disclosure herein, as well as others, will become more clearly apparent on reading the following description of at least one example of an embodiment, the description being given with reference to the appended drawings, in which:

FIG. 1 schematically illustrates an algorithm for selecting relevant terrain elevation information to be stored;

FIG. 2 schematically illustrates a conical filter shape which can be applied for selecting relevant terrain elevation information to be stored, in an embodiment;

FIG. 3A schematically illustrates a first example of a filtering profile applied to the vicinity of an airport strip;

FIG. 3B schematically illustrates a second example of a filtering profile applied to the vicinity of an airport strip;

FIG. 3C schematically illustrates a third example of a filtering profile applied to the vicinity of an airport strip;

FIG. 4 schematically illustrates, in a side view, an aircraft having avionics configured to use the stored relevant terrain elevation information; and

FIG. 5 schematically illustrates one example of a hardware platform which can be used to select the relevant terrain elevation information to be stored and/or use the stored relevant terrain elevation information.

### DETAILED DESCRIPTION

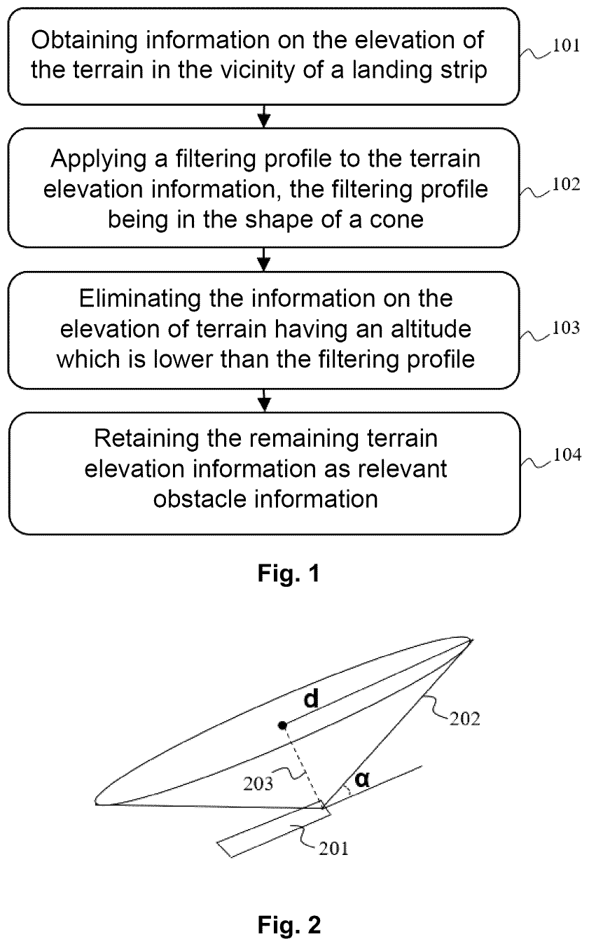

FIG. 1 thus schematically illustrates an algorithm for selecting relevant terrain elevation information to be stored. The algorithm of FIG. 1 is implemented by a system in the form of electronic circuitry, such as, for example, a computer system. The algorithm of FIG. 1 thus makes it possible to construct a simplified representation of obstacles in the vicinity of an airport strip. In an embodiment, the algorithm of FIG. 1 is repeated for several airport strips, in order to construct a database of simplified representations of obstacles in the vicinity of the airport strips.

In a step 101, the system obtains information on the elevation of the terrain in the vicinity of the airport strip. The terrain elevation information is, for example, obtained from a database referencing the topology of the environment of the airport, obtained by virtue of satellite images and/or ground surveys.

In a step 102, the system applies a filtering profile to the terrain elevation information. The filtering profile is in the shape of a cone the apex of which is placed at one end of the airport strip and the rotation axis of which is perpendicular to the airport strip. The outer surface of the cone defines a gradient which forms an angle α with the airport strip. The angle a is predetermined. For example, the angle α complies with regulatory minimum take-off and/or approach gradients.

Preferably, the angle α complies with a regulatory minimum approach (landing) gradient. Indeed, the gradient on take-off is typically higher than on landing. In addition, on take-off aircraft do not typically go up to the opposite threshold of the airport strip, while aircraft are more likely to land from this airport strip threshold in the opposite direction.

Knowing that this regulatory minimum approach gradient is very commonly 3 degrees, a conservative value of the angle α is, for example, 2 degrees.

In an embodiment, the value of the angle α used is specific to each airport strip, linked to approach (landing) constraints associated with this airport strip, instead of using a single value of the angle a to construct the whole database.

By way of illustration, a filtering profile 202 is schematically illustrated in FIG. 2. The filtering profile 202 is in the shape of a cone (having a rotation axis 203) the outer surface of which forms an angle a with an airport strip 201. The filtering profile 202 is represented over a distance d (radius of the base of the cone).

By applying the filtering profile, the system eliminates, in a step 103, the information on the elevation of terrain having an altitude which is lower than the filtering profile. Thus, in a step 104, the system retains (e.g. stores), as relevant obstacle information, the remaining terrain elevation information, that is to say that of an altitude which is higher than or equal to the filtering profile.

The relevant obstacle information thus stored may be used to determine or follow a flyable trajectory in the vicinity of an airport, be that during a take-off phase, during an approach phase or during a go-around procedure.

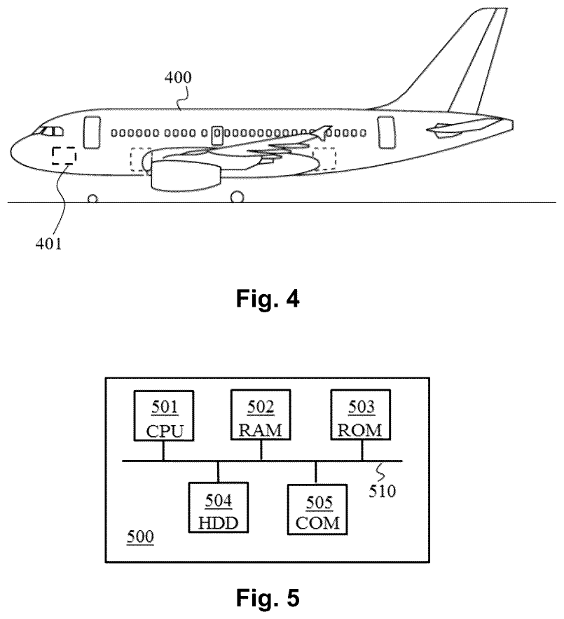

In an embodiment, the relevant obstacle information obtained by virtue of the filtering profile described in detail here is stored in a database of avionics 401 of an aircraft 400, as schematically illustrated in FIG. 4. Thus, the avionics 401 can determine a flyable trajectory in real time with a reduced amount of relevant obstacle information to be handled.

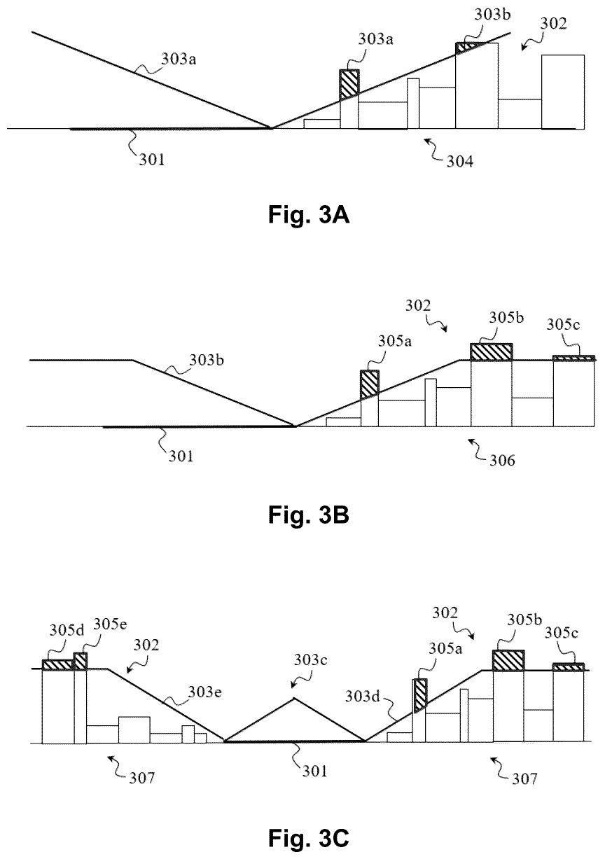

FIG. 3A schematically illustrates a first example of a filtering profile 303a applied to the vicinity of a landing strip 301. By applying a filtering profile in the shape of a cone, information on the elevation of the terrain 302 in the vicinity of the airport strip 301 is filtered, so that only the information on the elevation of terrain having an altitude which is higher than or equal to the cone is kept. Thus, information on the elevation of terrain 303a, 303b is retained (altitude higher than or equal to the cone), while information on the elevation of terrain 304 (altitude lower than the cone) is eliminated.

FIG. 3B schematically illustrates a second example of a filtering profile 303b applied to the vicinity of the airport strip 301. In this second example, at a distance d, the cone reaches a predetermined height h corresponding to a saturation threshold. Then, beyond the distance d with respect to the end of the airport strip 301, the filtering profile 303b is flat (fixed altitude). Thus, information on the elevation of terrain 305a, 305b, 305c is retained (altitude higher than or equal to the filtering profile), while information on the elevation of terrain 306 (altitude lower than the filtering profile) is eliminated.

FIG. 3C schematically illustrates a third example of a filtering profile 303c applied to the vicinity of the airport strip 301. In this third example, filtering in the shape of a cone, possibly with a saturation threshold, is applied to each end of the airport strip 301.

In an embodiment, the filtering profile to be applied is here obtained by combining a first filtering sub-profile 303d defined for one end of the airport strip 301 and a second filtering sub-profile 303e defined for the other end of the airport strip 301, so that the information on the elevation of terrain the altitude of which is lower than the lowest-altitude filtering sub-profile (from among the first filtering sub-profile 303d and the second filtering sub-profile 303e) is eliminated. The system thus obtains an individual filtering profile, to be applied for the whole of the airport strip. Thus, information on the elevation of terrain 305a, 305b, 305c, 305d, 305e is retained (altitude higher than or equal to the filtering profile), while information on the elevation of terrain 307 (altitude lower than the filtering profile) is eliminated.

In a variant, filtering according to the first filtering sub-profile 303d is carried out for one end of the airport strip 301 and, independently, filtering according to the second filtering sub-profile 303e is carried out for the other end of the airport strip 301, and the terrain elevation information remaining after each of these instances of filtering is grouped together as relevant obstacle information.

In an embodiment, when at least one other airport strip is nearby, an individual filtering profile is defined for each airport strip (as explained above), and an overall filtering profile is obtained by combining the individual filtering profiles, so that the information on the elevation of terrain the altitude of which is lower than the lowest-altitude individual filtering profile is eliminated. The overall filtering profile can thus be applied to all of the airport strips in question.

FIG. 5 schematically illustrates one example of a hardware platform 500 which can be used to select the relevant terrain elevation information to be stored, by applying the filtering profile described in detail above, in any one of its embodiments. The hardware platform 500 can also be used to use this relevant terrain elevation information once stored.

The example of a hardware platform 500 can notably be used as a component of a computerized system on the ground.

The example of a hardware platform 500 can notably be used as a component of the avionics 401.

In FIG. 5, the hardware platform 500 comprises, connected by a communication bus 510: a processor or CPU (central processing unit) 501; a random-access memory (RAM) 502; a read-only memory (ROM) 503, for example a flash memory; a data storage device, such as a hard disk drive (HDD), or a storage medium reader, such as an SD (Secure Digital) card reader 504; at least one communication interface (COM) 505 and/or an input-output assembly (I/O).

The communication interface (COM) 505 and/or an input-output assembly (I/O) make it possible for the hardware platform 500 to interact with third-party equipment, for example via ground-to-air communications.

The processor 501 is capable of executing instructions loaded into the RAM 502 from the ROM 503, from an external memory, from a storage medium, such as an SD card, or from a communication network. When the hardware platform 500 is powered up, the processor 501 is capable of reading instructions from the RAM 502 and of executing them. These instructions form a computer program which causes the processor 501 to implement the behaviors, steps and algorithms described here.

All or some of the behaviors, steps and algorithms described here may thus be implemented in software form by executing an instruction set by a programmable machine, such as a DSP (digital signal processor) or a microcontroller, or be implemented in hardware form by a machine or a dedicated component (chip) or a dedicated set of components (chipset), such as an FPGA (field-programmable gate array) or an ASIC (application-specific integrated circuit). Generally, the hardware platform 500 constitutes a system in the form of electronic circuitry arranged and configured to implement the behaviors, steps and algorithms described here.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for constructing a simplified representation of obstacles in a vicinity of an airport strip, the method being implemented by a system comprising electronic circuitry, the method comprising:
obtaining information on an elevation of terrain in the vicinity of the airport strip;
applying filtering by following a filtering profile in a shape of a cone, an apex of which is placed at one end of the airport strip, a rotation axis of the cone being perpendicular to the airport strip, the cone having an outer surface forming a predetermined angle with the airport strip, the filtering eliminating information on the elevation of terrain having an altitude which is lower than the filtering profile; and
storing, as relevant obstacle information, the terrain elevation information remaining after filtering.

2. The method of claim 1, wherein, at a distance, the cone shape reaches a predetermined height corresponding to a saturation threshold and, beyond the distance with respect to the end of the airport strip, the filtering profile is flat.

3. The method of claim 1, wherein the system applies one filtering profile to each end of the airport strip.

4. The method of claim 3, wherein the system obtains a filtering profile to be applied for a whole of the airport strip, that is an individual filtering profile, by combining a first filtering sub-profile defined for one end of the airport strip and a second filtering sub-profile defined for another end of the airport strip, so that the information on the elevation of terrain the altitude of which is lower than the lowest-altitude filtering sub-profile is eliminated.

5. The method of claim 4, wherein, when at least one other airport strip is nearby, the system defines one individual filtering profile for each airport strip, and the system obtains an overall filtering profile to be applied for all of the airport strips, by combining the individual filtering profiles, so that the information on the elevation of terrain the altitude of which is lower than the lowest-altitude individual filtering profile is eliminated.

6. A method for determining or for following a trajectory of an aircraft in a vicinity of an airport, wherein a system comprising electronic circuitry determines or follows a trajectory of an aircraft by using a simplified representation of obstacles in the vicinity of the airport strip which is obtained by the method of claim 1.

7. A computer program product comprising program code instructions causing the method of claim 1 to be implemented when the instructions are executed by a processor.

8. An information storage medium storing program code instructions causing the method of claim 1 to be implemented when the instructions are read and executed by a processor.

9. A system in a form of electronic circuitry configured to construct a simplified representation of obstacles in a vicinity of an airport strip by:
obtaining information on an elevation of terrain in the vicinity of the airport strip;
applying filtering by following a filtering profile in a shape of a cone, an apex of which is placed at one end of the airport strip, a rotation axis of the cone being perpendicular to the airport strip, the cone having an outer surface forming a predetermined angle with the airport strip, the filtering eliminating information on the elevation of terrain having an altitude which is lower than the filtering profile; and
storing, as relevant obstacle information, the terrain elevation information remaining after filtering.
